(19) United States
(12) Patent Application Publication
(10) Pub. No.: US 2025/0058390 A1
(43) Pub. Date: Feb. 20, 2025

(54) CONTROL METHOD OF WIRE ELECTRIC DISCHARGE MACHINE AND WIRE ELECTRIC DISCHARGE MACHINE

(71) Applicant: MAKINO MILLING MACHINE CO., LTD., Tokyo (JP)

(72) Inventors: Tadashi KIMURA, Kanagawa (JP); Arata DEGUCHI, Kanagawa (JP); Hiroki FUKURODATE, Kanagawa (JP)

(73) Assignee: MAKINO MILLING MACHINE CO., LTD., Tokyo (JP)

(21) Appl. No.: 18/723,394

(22) PCT Filed: Dec. 27, 2022
(86) PCT No.: PCT/JP2022/048291

§ 371 Date: Jun. 21, 2024

(30) Foreign Application Priority Data
Dec. 28, 2021 (JP) 2021-214637

(51) Int. Cl. B23H 7/10; B23H 7/20; B23H 7/30

(52) U.S. Cl. CPC B23H 7/101; B23H 7/20; B23H 7/30

(57) ABSTRACT

Provided is a wire electric discharge machine which processes a workpiece by applying prescribed pulse power between a traveling wire electrode and the workpiece, wherein in the machine: a working liquid is supplied to nozzles, which jet the working liquid in the traveling direction of the wire electrode, by means of supply pumps by adhering, to the workpiece, the nozzles; the supply pumps are controlled through constant pressure control for controlling the pressure of the working liquid supplied to the nozzles to a prescribed constant pressure; the frequency of a current is measured, the current being supplied to the supply pumps, which supply the working liquid to the nozzles, by moving the workpiece to the wire electrode in a traverse direction of the traveling direction of the wire electrode; and the supply pump control is switched from the constant pressure control to a constant flow rate control, for supplying the working liquid of a constant flow rate to the nozzles, when the measured frequency exceeds a threshold frequency.

### FIELD

The present invention relates to a method for controlling a wire electric-discharge machine and a wire electric-discharge machine for machining a workpiece having undulations the height direction positions of which change.

### BACKGROUND

Patent Literature 1 describes a wire electric-discharge machine which ejects machining fluid under constant pressure toward an electrical discharge machining unit between a workpiece and a wire electrode, wherein the machining fluid flow rate is detected, and the pulsed power is reduced when the detected machining fluid flow rate is not within an appropriate range.

Patent Literature 2 describes a wire electric-discharge machine, wherein before performing electrical discharge machining, simulated operation is performed while supplying a machining fluid jets at predetermined pressures from the upper and lower machining fluid jet nozzles toward the surface of a workpiece, the pressures of the machining fluid at the upper and lower machining fluid jet nozzles are measured and stored in association with relative positions on a relative movement trajectory, and during actual electrical discharge machining, the stored load pressures are compared with the measured load pressures, and the machining conditions are changed step by step to gradually increase or decrease the electrical discharge energy at stepped portions.

### CITATION LIST

### Patent Literature

[PTL 1] Japanese Unexamined Patent Publication (Kokai) No. 11-048040
[PTL 2] Japanese Unexamined Patent Publication (Kokai) No. 2010-240761

### SUMMARY

### Technical Problem

In a wire electric-discharge machine which performs electrical discharge machining by applying pulsed power between a wire electrode and a workpiece while ejecting machining fluid from a nozzle toward the electrical discharge machining unit as described in Patent Literature 1 and 2, when machining a workpiece that has a substantially discontinuous undulating surface, such as recesses formed in the surface of the workpiece, if the wire electrode is exposed in a recess, the wire electrode may vibrate and break, or streak-like machining marks may be formed on the machined surface of the workpiece. These problems cannot be solved by the wire electric-discharge machines described in Patent Literature 1 and 2.

The present invention has been conceived in light of the problems of the prior art, and an object thereof is to provide a method for controlling a wire electric-discharge machine which is configured such that when machining a workpiece with undulations using a wire electric-discharge machine, changes in the shape of the workpiece are detected before machining the shape change area, and the machining fluid supply is changed to match the change, as well as a wire electric-discharge machine.

### Solution to Problem

In order to achieve the object described above, according to the present invention, there is provided a method for controlling a wire electric-discharge machine for applying a predetermined pulsed power between a traveling wire electrode and a workpiece to machine the workpiece, the method comprising the steps of bringing a nozzle for ejecting machining fluid in a travel direction of the wire electrode into close contact with the workpiece, supplying machining fluid to the nozzle by a supply pump, controlling the supply pump by constant pressure control to maintain a pressure of the machining fluid supplied to the nozzle at a predetermined constant pressure, moving the workpiece relative to the wire electrode in a direction transverse to the travel direction of the wire electrode, measuring the frequency of current supplied to the supply pump for supplying the machining fluid to the nozzle, and switching control of the supply pump from constant pressure control to constant flow rate control for supplying a constant flow rate of machining fluid to the nozzle when the measured frequency exceeds a predetermined threshold frequency.

Further, according to the present invention, there is provided a method for controlling a wire electric-discharge machine for applying a pulsed power between a workpiece and a wire electrode traveling between an upper nozzle and a lower nozzle for ejecting a machining fluid, ejecting the machining toward the workpiece form the upper nozzle and the lower nozzle and machining the workpiece, the method comprising the steps of arranging the workpiece such that an upper surface and a bottom surface of the workpiece face each other in the travel direction of the wire electrode, positioning the upper nozzle so that it can come into close contact with a highest upper surface of the workpiece, positioning the lower nozzle so that it can come into close contact with a lowest bottom surface of the workpiece, supplying the machining fluid to each of the upper nozzle and lower nozzle at a predetermined constant pressure, moving the workpiece relative to the wire electrode in a direction transverse to the travel direction of the wire electrode, measuring a frequency of a current supplied to a first supply pump for supplying machining fluid to the upper nozzle and a pressure of the machining fluid supplied to the upper nozzle, measuring a frequency of a current supplied to a second supply pump for supplying machining fluid to the lower nozzle and a pressure of the machining fluid supplied to the lower nozzle, while the upper nozzle is in close contact with the upper surface of the workpiece, controlling the first supply pump by constant pressure control for maintaining the pressure of the machining fluid supplied to the upper nozzle at a predetermined constant pressure, while the lower nozzle is in close contact with the bottom surface of the workpiece, controlling the second supply pump by constant pressure control for maintaining the pressure of the machining fluid supplied to the lower nozzle at a predetermined constant pressure, and when the frequency of either or both of the current supplied to the first supply pump and the current supplied to the second supply pump exceeds a predetermined threshold frequency, switching the control of the supply pump that is supplied with a current exceeding the threshold frequency from the constant pressure control to constant flow rate control for discharging the machining fluid at a predetermined constant flow rate.

Furthermore, according to the present invention, there is provided a wire electric-discharge machine for applying a pulsed power between a workpiece and a wire electrode traveling between an upper nozzle and a lower nozzle for ejecting a machining fluid, ejecting the machining toward the workpiece form the upper nozzle and the lower nozzle and machining the workpiece, comprising a workpiece mount for positioning the workpiece such that an upper surface and a bottom surface of the workpiece face each other in the travel direction of the wire electrode, an upper nozzle which can come into close contact with a highest upper surface of the workpiece, a lower nozzle which can come into close contact with a lowest bottom surface of the workpiece, first and second supply pumps for supplying the machining fluid to each of the upper nozzle and lower nozzle, a feed device for moving the workpiece mount to which the workpiece is affixed relative to the wire electrode in a direction transverse to the travel direction of the wire electrode, first and second pressure gauges for measuring discharge pressures of the first and second supply pumps, and a controller for controlling the first and second supply pumps, wherein the controller, while the upper nozzle is in close contact with the upper surface of the workpiece, controls the first supply pump by constant pressure control for maintaining the pressure of the machining fluid supplied to the upper nozzle at a predetermined constant pressure, while the lower nozzle is in close contact with the bottom surface of the workpiece, controls the second supply pump by constant pressure control for maintaining the pressure of the machining fluid supplied to the lower nozzle at a predetermined constant pressure, and when the frequency of either or both of a current supplied to the first supply pump and a current supplied to the second supply pump exceeds a predetermined threshold frequency, switches the control of the supply pump that is supplied with a current exceeding the threshold frequency from the constant pressure control to constant flow rate control for discharging the machining fluid at a predetermined constant flow rate.

### Advantageous Effects of Invention

According to the present invention, the frequency of the current supplied to the pump is measured, and when the measured frequency exceeds a predetermined threshold frequency, the control of the pump is changed from constant pressure control to constant flow rate control, in which machining fluid is supplied to the nozzle at a predetermined constant flow rate, whereby vibration of the wire electrode exposed in the recess of the workpiece, which causes breakage of the wire electrode and formation of streak-like machining marks on the machined surface of the workpiece, is prevented. By controlling the machining power conditions to a predetermined value in conjunction with changing the machining fluid supply, the machining time can be shortened without unnecessarily reducing machining efficiency. This control can be performed independently for undulations in which the height position of the upper surface of the workpiece changes and for undulations in which the height position of the bottom surface of the workpiece changes.

### BRIEF DESCRIPTION OF DRAWINGS

FIG. 1 is a block diagram of a controller for a wire electric-discharge machine according to a preferred embodiment of the present invention.

FIG. 2 is a schematic view of machining of an undulating workpiece.

FIG. 3 is a plan view as viewed in the direction of arrow line III-III of FIG. 2.

FIG. 4 is a schematic view detailing an opening formed in a leading portion of an upper nozzle when the upper nozzle reaches position X-2 in FIGS. 2 and 3 during machining and approaches the side wall of a recess of a workpiece.

FIG. 5 is a schematic view illustrating that the leading portion of the upper nozzle is blocked by an upper surface of the workpiece when the upper nozzle reaches position X-3 in FIGS. 2 and 3 and approaches the opposite side wall of the recess of the workpiece during machining.

FIG. 6 is a graph showing changes in the frequency of alternating current supplied to the supply pump and the discharge pressure of the supply pump.

### DESCRIPTION OF EMBODIMENTS

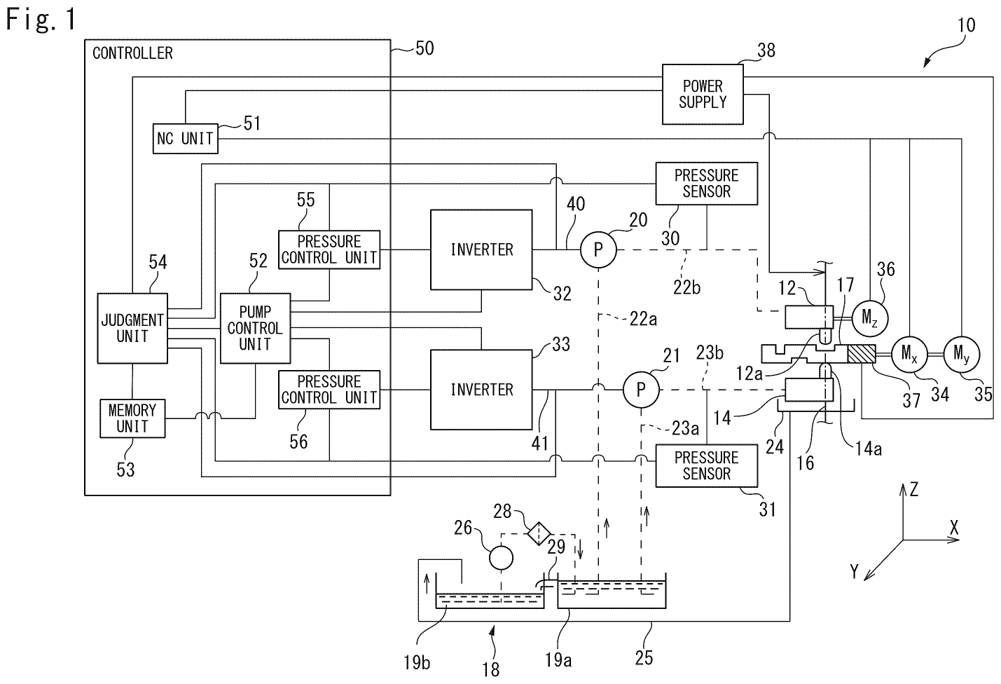

FIG. 1 is a view showing an electric discharge machine according to a preferred embodiment of the present invention.

A wire electric-discharge machine 10 comprises upper and lower heads 12, 14 which are arranged opposite each other, a workpiece mount 37 for affixation of a workpiece 17, a machining fluid supply device 18 for supplying machining fluid to the electrical discharge machining part, a power supply 38 for applying a predetermined pulse voltage between a wire electrode 16 and the workpiece 17, and a controller 50 for controlling the operations of the wire electric-discharge machine 10.

The wire electrode 16 is supplied from an unillustrated wire electrode supply reel so as to travel between the upper and lower heads 12, 14 via a travel path defined by a plurality of guide rollers (not illustrated), and is collected in a wire electrode collection device (not illustrated). The workpiece 17 is affixed to the workpiece mount 37 and is arranged between the upper and lower heads 12, 14, and more specifically, between the nozzle 12a (upper nozzle 12a) of the upper head 12 and the nozzle 14a (lower nozzle 14a) of the lower head 14.

In the present disclosure, the Z-axis is defined in the travel direction of the wire electrode 16, and the X-axis and Y-axis are defined in two directions orthogonal to each other within a plane perpendicular to the travel direction of the wire electrode 16. Typically, the Z-axis is defined in the vertical direction, and the X-axis and a Y-axis are defined in the two orthogonal horizontal directions. In FIG. 1, the Y-axis is defined in a direction perpendicular to the paper surface, the X-axis is defined in the left-right direction, and the Z-axis is defined in the up-down direction.

The wire electrode 16 and the workpiece 17 are connected to a power supply 38, and a predetermined pulsed power is applied between them. As a result, an electric discharge occurs between the wire electrode 16 and the workpiece 17, and the workpiece 17 is subjected to electric discharge machining by the energy of this electric discharge. The wire electrode 16 is connected to the power supply 38 via a feed terminal (not illustrated) arranged within or near the upper head 12. The workpiece 17 is connected to the power supply 38 via the workpiece mount 37. During the electrical discharge machining process, the workpiece 17 receives feed control in the XY plane together with the workpiece mount 37, whereby the electrical discharge machining progresses along the desired trajectory, and a product having a desired shape is machined from the workpiece 17.

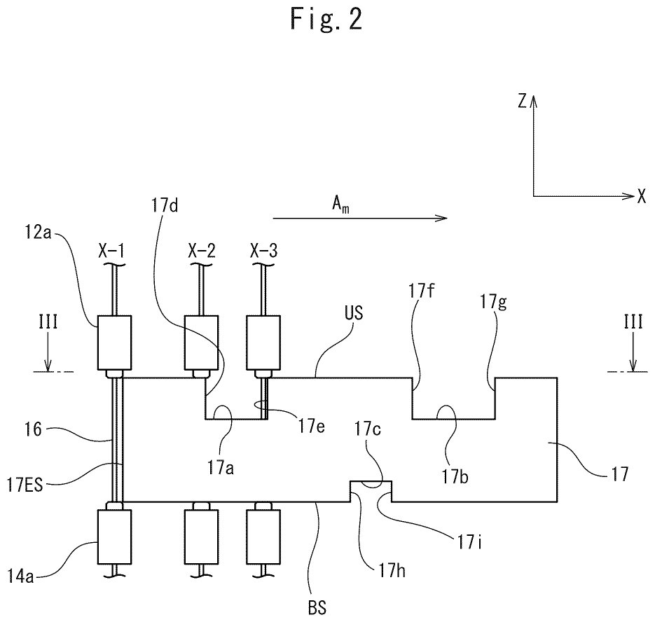

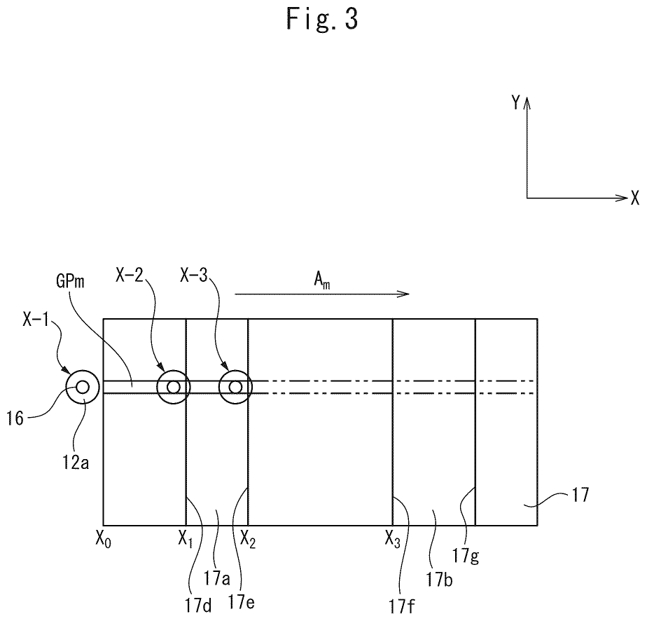

Note that the workpiece 17 is a workpiece having a substantially discontinuous undulating surface facing either or both of the upper nozzle 12a and the lower nozzle 14a. Referring to FIGS. 2 and 3, the workpiece 17 shown as an example has recesses 17a, 17b formed in the upper surface US facing the upper nozzle 12a, a recess 17c is formed in the bottom surface BS facing the lower nozzle 14a. The recesses 17a, 17b, and 17c are recessed in a step-like shape, and typically, each side wall 17d, 17e; 17f, 17g; 17h, 17i is approximately parallel to the travel direction of the wire electrode 16 or the Z-axis direction.

In the present embodiment, the wire electric-discharge machine 10 comprises an X-axis feed device (not illustrated) and a Y-axis feed device (not illustrated) which feed the workpiece mount 37 in the X-axis and Y-axis directions, respectively, and the workpiece mount 37 is provided so as to be movable in the X-axis and Y-axis directions. Furthermore, the wire electric-discharge machine 10 comprises a Z-axis feed device (not illustrated) for positioning the upper head 12 in the Z-axis direction. In the present embodiment, the lower head 14 is affixed to a stationary part (not illustrated) such as a column of the wire electric-discharge machine 10, and only the upper head 12 is movable in the Z-axis direction. By fixing the workpiece 17 to the workpiece mount 37 at an appropriate height using a jig (not illustrated), the lower head 14 and the workpiece 17 are positioned relative to each other in the Z-axis direction.

The X-axis, Y-axis, and Z-axis feed devices can comprise an X-axis ball screw (not illustrated), a Y-axis ball screw (not illustrated), and a Z-axis ball screw (not illustrated) extending in the X-axis, Y-axis, and Z-axis directions, respectively, nuts attached to the workpiece mount 37 for engaging with the X-axis ball screw and the Y-axis ball screw, respectively, a nut attached to the upper head 12 for engaging with the Z-axis ball screw, and an X-axis servo motor 34, a Y-axis servo motor 35, and a Z-axis servo motor 36 coupled to one end of the X-axis ball screw, the Y-axis ball screw, and the Z-axis ball screw, respectively. The X-axis, Y-axis, and/or Z-axis feed device may use a linear motor (not illustrated) comprising a stator (not illustrated) extending in the X-, Y-, or Z-axis direction instead of a combination of a ball screw and a servo motor.

The machining fluid supply device 18 comprises a clean tank 19a for storing clean machining fluid, a recovery tank 19b for recovering machining fluid used in the electrical discharge machining, a filtration pump 26 for supplying machining fluid from the recovery tank 19b to the clean tank 19a, a filter 28 disposed on outlet side piping of the filtration pump 26, a first supply pump 20 for supplying machining fluid from the clean tank 19a to the upper head 12 via supply pipes 22a, 22b, and a second supply pump 21 for supplying machining fluid from the clean tank 19a to the lower head 14 via supply pipes 23a, 23b. A regulating pipe 29 may be provided between the clean tank 19a and the recovery tank 19b, whereby the machining fluid overflowing from the clean tank 19a may be recovered into the recovery tank 19b.

The first and second supply pumps 20, 21 are pumps having variable flow rates, and as an example, in the following description, are constituted by an inverter pump which can control the discharge flow rate by controlling the frequency of the alternating current supplied to the first and second supply pumps 20, 21. Specifically, the first and second supply pumps 20, 21 are configured to control the discharge flow rate by controlling the rotation speed. The discharge flow rate of such pumps is generally approximately proportional to the frequency of the alternating current supplied to the motor driving the pump.

First and second pressure sensors 30, 31 are disposed in the supply pipes 22b, 23b downstream of the first and second supply pumps 20, 21, respectively, and measure the pressure of the machining fluid discharged from the first and second supply pumps 20, 21 or the pressure of the machining fluid supplied to the upper and lower heads 12, 14.

The upper and lower heads 12, 14 are provided with upper and lower nozzles 12a, 14a for machining fluid supply. The upper nozzle 12a is affixed to the upper head 12 and positioned in the Z-axis direction together with the upper head 12 by the Z-axis feed device. The lower nozzle 14a is affixed to the lower head 14. Machining fluid is supplied from the machining fluid supply device 18 to the upper and lower heads 12, 14. The machining fluid supplied to the upper and lower heads 12, 14 is ejected toward the workpiece 17 from the upper and lower nozzles 12a, 14a.

More specifically, the machining fluid supplied from the clean tank 19a to the upper head 12 via the supply pipes 22a, 22b by the first supply pump 20 is ejected from the upper nozzle 12a toward the upper surface US of the workpiece 17. The machining fluid supplied from the clean tank 19a to the lower head 14 via the supply pipes 23a, 23b by the second supply pump 21 is ejected from the lower nozzle 14a toward the bottom surface BS of the workpiece 17.

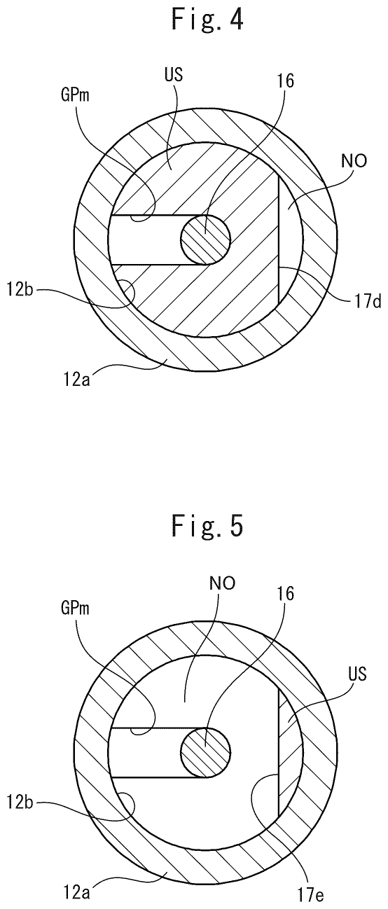

Circular holes (funnels) 12b, 14b (refer to FIG. 4) are formed at the tips of each of the upper nozzle 12a and the lower nozzle 14a, and the wire electrode 16 is inserted through the center of these holes. The wire electrode 16 is centered relative to the upper nozzle 12a and lower nozzle 14a in the XY plane by wire guides (not illustrated) disposed within the upper head 12 and lower head 14. The upper and lower heads 12, 14 are positioned in the Z-axis direction relative to the workpiece 17 such that the tips of the upper and lower nozzles 12a, 14a are in close contact with the surface of the workpiece 17. More specifically, the upper nozzle 12a is arranged so as to come into close contact with the highest surface of the upper surface US of the workpiece 17, and the lower nozzle 14a is arranged so as to come into close contact with the lowest surface of the bottom surface BS of the workpiece 17. In a state in which the upper and lower nozzles 12a, 14a are in close contact with the upper surface US and bottom surface BS of the workpiece 17, respectively, machining fluid is supplied in the form of a jet from the upper and lower nozzles 12a, 14a into the gap GPm (refer to FIG. 3) of the machining trajectory formed by the wire electric discharge machining.

In the present embodiment, the first and second supply pumps 20, 21 are connected to first and second inverters 32, 33, and the pressure of machining fluid discharged from the first and second supply pumps 20, 21 can be independently controlled by controlling the frequency of the alternating current supplied from the first and second inverters 32, 33 to each drive motor (not illustrated). Though two inverters (first and second inverters 32, 33) are illustrated in FIG. 1, a single inverter comprising two output ports which can independently change the frequency of the output alternating current may also be used.

The machining fluid ejected from the upper and lower nozzles 12a, 14a toward the workpiece 17 removes heat and machining debris generated by the wire electrical discharge machining, is then received in a machining fluid pan 24 as a machining fluid recovery part arranged below the lower nozzle 14a, and is returned from the machining fluid pan 24 to the machining fluid recovery tank 19b via a recovery pipe 25. From there, it is sent to the clean tank 19a via the filtration pump 26 and filter 28 and reused. The recovery pipe 25 may comprise a recovery pump (not illustrated) for pumping the machining fluid from the machining fluid pan 24 toward the recovery tank 19b.

The controller 50 comprises an NC unit 51, a pump control unit 52, first and second pressure control units 55, 56, a memory unit 53, and a judgment unit 54 as primary components. The pump control unit 52, the first and second pressure control units 55, 56, the memory unit 53, and the judgment unit 54 can be configured as a computer comprising a CPU (central processing element), memory devices such as RAM (random access memory) and ROM (read-only memory), input/output ports, and bidirectional buses interconnecting them, as well as associated software. The controller 50 may comprise a storage device such as an HDD (hard disk drive) or an SSD (solid state drive).

The NC unit 51 can be formed by a general NC device, reads and interprets a machining program input to the NC unit, and controls the X-axis, Y-axis, and Z-axis servo motors 34, 35, and 36. The power supply 38 can be started and stopped based on a power on/off command written in the machining program read by the NC unit 51. The pump control unit 52, the first and second pressure control units 55, 56, the memory unit 53, and the judgment unit 54 may be configured as part of the NC device forming the NC unit 51.

The pump control unit 52 is directly connected to the first and second inverters 32, 33, and is also connected to the first and second inverters 32, 33 via the first and second pressure control units 55, 56. The pump control unit 52 outputs frequency command values to the first and second inverters 32, 33, and controls the frequency of the alternating current output from the first and second inverters 32, 33 to the first and second supply pumps 20, 21, whereby the first and second supply pumps 20, 21 can be controlled.

The pump control unit 52 independently outputs a target pressure command to the first and second pressure control units 55, 56 while the first and second supply pumps 20, 21 are subjected to constant pressure control, which will be described later. Since the appropriate pressure for the target pressure changes depending on the thickness (size in the travel direction of the wire electrode 16) of the workpiece 17, appropriate values can be determined in advance via experimentation or the like and stored in the memory unit 53 in relation to the thickness of the workpiece 17.

The first and second pressure control units 55, 56 are connected to the first and second inverters 32, 33, and are connected to the first and second pressure sensors 30, 31 arranged in the supply pipes 22b, 23b downstream of the first and second supply pumps 20, 21, respectively. The relationship between the discharge pressure of the first and second supply pumps 20, 21 and the frequency of the alternating current supplied to the first and second supply pumps 20, 21 can be determined in advance via experimentation.

The first and second pressure control units 55, 56 output frequency command values to the first and second inverters 32, 33 based on the difference between the target pressure command value from the pump control unit 52 and the discharge pressure (measured pressure) of the first and second supply pumps 20, 21 detected by the first and second pressure sensors 30, 31 so that the discharge pressures of the first and second supply pumps 20, 21 become the target pressure.

As described above, the first supply pump 20 is controlled to have a constant frequency by the first inverter 32, and discharges machining fluid in proportion to the frequency of the supplied alternating current. In general, since flow rate is proportional to the square root of pressure (Bernoulli's theorem), a frequency command is output from the first and second pressure control units 55, 56 to the first and second inverters 32, 33 so that the increment in the frequency of the alternating current supplied from the first and second inverters 32, 33 to the first and second supply pumps 20, 21 is proportional to the square root of the difference between the target pressure and the measured pressure.

Since the frequency of the alternating current supplied to the first and second supply pumps 20, 21 and the discharge pressure of the first and second supply pumps 20, 21 vary depending on the thickness (size in the travel direction of the wire electrode 16) of the workpiece 17, the relationship between frequency and discharge pressure can be determined in advance via experimentation or the like and stored in the memory unit 53.

The pump control unit 52 can control the first and second supply pumps 20, 21 by feedback control in this manner so that the discharge pressure of the first and second supply pumps 20, 21 is set to the target pressure commanded by the pump control unit 52.

The pump control unit 52 controls the first and second supply pumps 20, 21 by constant frequency control in which direct frequency command values are output to the first and second inverters 32, 33, and constant pressure control in which pressure commands are output to the first and second pressure control units 55, 56 in this manner. In the present embodiment, as will be described later, the pump control unit 52 switches between constant frequency control and constant pressure control based on the judgment result from the judgment unit 54.

The judgment unit 54 is connected to the first and second pressure sensors 30, 31 provided in the downstream pipes 22b, 23b of the first and second supply pumps 20, 21, respectively, and outputs 40, 41 of the first and second inverters 32, 33 to the first and second supply pumps 20, 21. The judgment unit 54 is further connected to the power supply 38.

As described above, in the present invention, the workpiece 17 is an undulating workpiece having discontinuous recesses on the surface facing either or both of the upper nozzle 12a and the lower nozzle 14a. Referring to FIGS. 2 and 3, as an example, the workpiece 17 has recesses 17a, 17b formed in the upper surface US facing the upper nozzle 12a, and a recess 17c formed in the bottom surface BS facing the lower nozzle 14a.

The workpiece 17 affixed to the workpiece mount 37 is fed along with the workpiece mount 37 in the XY plane by the X-axis feed device and the Y-axis feed device (only the X-axis servo motor 34 and the Y-axis servo motor 35 are shown in FIG. 1). In FIGS. 2 and 3, which illustrate an example, the workpiece 17 is shown as moving to the left along the X-axis, and as a result, the upper nozzle 12a and the lower nozzle 14a are shown as moving in the direction of arrow Am relative to the workpiece 17. Specifically, in FIGS. 2 and 3, arrow Am indicates the relative movement of the upper and lower nozzles 12a, 14a relative to the workpiece 17.

In FIGS. 2 and 3, X-1 indicates the position immediately before the wire electrode 16 engages with the edge 17ES of the workpiece 17 (the relative position of the upper and lower nozzles 12a, 14a and the wire electrode 16 relative to the workpiece 17), X-2 indicates the position immediately before the upper and lower nozzles 12a, 14a move relative to the workpiece 17 from X-1 in the direction of arrow Am and the wire electrode 16 ruptures the side wall 17d of the recess 17a, and X-3 indicates the position immediately before the wire electrode 16 further moves relative to the workpiece 17 in the direction of arrow Am across the recess 17a and engages with the opposite side wall 17e facing the side wall 17d of the recess 17a.

FIG. 4 is an enlarged view showing the positional relationship between the upper nozzle 12a and the recess 17a of the workpiece 17 when the upper nozzle 12a is at position X-2. When the upper nozzle 12a reaches position X-2 and approaches the side wall 17d of the recess 17a of the workpiece 17, the leading portion of the upper nozzle 12a no longer contacts the upper surface of the workpiece 17, and as shown in FIG. 4, an opening NO is formed in the leading portion of the upper nozzle 12a. At this time, the wire electrode 16 has not yet reached the side wall 17d of the recess 17a.

As described above, the upper nozzle 12a moves in the direction of arrow Am relative to the workpiece 17 while being in close contact with the upper surface of the workpiece 17. Thus, the machining fluid ejected from the upper nozzle 12a flows into the gap GPm of the machining trajectory formed by the wire electric discharge machining. During this time, the first supply pump 20 is subjected to constant pressure control so that the discharge pressure is constant.

As described above, when the upper nozzle 12a approaches the side wall 17d of the recess 17a of the workpiece 17 and the opening NO appears, the machining fluid from the funnel 12b of the upper nozzle 12a flows not only into the gap GPm but also into the opening NO. Since the area of the opening NO gradually increases as the upper nozzle 12a moves further in the direction of arrow Am, during the movement of the upper nozzle 12a, the pressure in the supply pipe 22b on the downstream side of the first supply pump 20 detected by the first pressure sensor 30 tends to decrease.

When the upper nozzle 12a further moves in the direction of arrow Am relative to the workpiece 17 and the wire electrode 16 ruptures the side wall 17d of the recess 17a, a portion of the wire electrode 16 is exposed within the recess 17a. The portion of the wire electrode 16 exposed within the recess 17a vibrates due to the machining fluid ejected from the upper nozzle 12a, causing the wire electrode 16 to break or the machined surface to be damaged in streaks. In the present invention, in order to prevent this, the flow rate of the machining fluid discharged from the upper nozzle 12a is reduced, as will be described later, immediately before the wire electrode 16 is exposed in the recess 17a.

As described above, when the opening NO appears, the first supply pump 20 is subjected to constant pressure control so that the discharge pressure is constant. Thus, when the difference between the target pressure command value from the pump control unit 52 and the discharge pressure of the first supply pump 20 detected by the first pressure sensor 30 increases due to a decrease in the pressure in the supply pipe 22b, the first pressure control unit 55 commands the first inverter 32 to increase the frequency of the alternating current supplied to the first supply pump 20. As a result, the frequency of the alternating current supplied to the first supply pump 20 gradually increases.

In the present embodiment, when the frequency of the alternating current supplied to the first supply pump 20 exceeds a predetermined threshold (threshold frequency) while the first supply pump 20 is under constant pressure control, the control of the first supply pump 20 is switched from constant pressure control in which the discharge pressure is constant to constant frequency control in which alternating current having a predetermined constant frequency is supplied to the first supply pump 20. At this time, an appropriate value for the threshold frequency can be determined in advance via experimentation or the like.

The judgment unit 54 monitors the frequency of the alternating current output by the first inverter 32 while the first supply pump 20 is under constant pressure control in this manner, and when this exceeds the threshold frequency, the control of the first supply pump 20 is switched from constant pressure control to constant flow rate control. Specifically, the judgment unit 54 commands the pump control unit 52 to switch the control method of the first supply pump 20. In this manner, the method of supplying machining fluid to the upper nozzle 12a is switched from a predetermined constant pressure to a predetermined constant flow rate.

When the frequency of the alternating current output by the first inverter 32 exceeds the threshold frequency, the judgment unit 54 commands the power supply 38 to reduce the pulsed power applied between the wire electrode 16 and the workpiece 17 to a predetermined low pulsed power. This pulsed power can be reduced by reducing one or both of pulse width and pulse current.

The predetermined constant flow rate of the machining fluid at this time can be determined in advance via experimentation or the like. In this case, a flow rate meter (not illustrated) for measuring the flow rate of machining fluid is disposed in the supply pipe 22b on the downstream side of the first supply pump 20, and the flow rate of the machining fluid flowing through the supply pipe 22b can be controlled by feedback control.

The predetermined constant flow rate of the machining fluid and the low pulsed power may be changed depending on the respective depths of the recesses 17a, 17b. In this case, the flow rate of the machining fluid and the low pulsed power can be stored in the memory unit 53 in relation to the respective depths of the recesses 17a, 17b. Furthermore, the depths of the recesses 17a, 17b can be manually input into the controller 50 by an operator. The respective depths of the recesses 17a, 17b are entered in the machining program for the workpiece 17 in relation to the position coordinates of the recesses 17a, 17b, and the judgment unit 54 may judge the depth of the recess 17a or 18b by reading the depths of the recesses 17a, 17b from the NC unit 51 during machining and comparing them with the X and Y coordinate values when the frequency of the alternating current output by the first inverter 32 exceeds the threshold frequency.

Furthermore, since the flow rate of the machining fluid discharged from the upper nozzle 12a is proportional to the frequency of the alternating current supplied to the first supply pump 20, as a result, machining fluid at a predetermined flow rate is ejected from the upper nozzle 12a. Thus, when the frequency of the alternating current output by the first inverter 32 exceeds the threshold frequency, instead of controlling the discharge flow rate of the first supply pump 20 so as to be constant, the frequency of the alternating current output from the first inverter 32 may be controlled to a predetermined constant frequency.

In the present embodiment, when a command to switch the control method from constant pressure control to constant flow rate control is received from the judgment unit 54, the pump control unit 52 issues a command to the first pressure control unit 55 to stop outputting the command to the first inverter 32, alternatively, the target pressure output to the first pressure control unit 55 may be set to 0 (zero), and a command to supply an alternating current of a predetermined constant frequency to the first supply pump 20 may be sent to the first inverter 32, or alternatively, a certain frequency of the alternating current to be supplied to the first supply pump 20 is specified. As a result, alternating current having a predetermined constant frequency is supplied to the first supply pump 20. The constant frequency during constant frequency control of the first supply pump 20 can be determined in advance via experimentation or the like.

This constant frequency may be changed depending on the respective depths of the recesses 17a, 17b. In this case, a plurality of constant frequencies can be stored in the memory unit 53 in association with the respective depths of the recesses 17a, 17b. Furthermore, the depths of the recesses 17a, 17b can be manually input into the controller 50 by an operator. The depths of the recesses 17a, 17b are entered in the machining program for the workpiece 17 in relation to the position coordinates of the recesses 17a, 17b, and the judgment unit 54 may judge the depth of the recess 17a or 17b by reading the depths of the recesses 17a, 17b from the NC unit 51 during machining and comparing them with the X and Y coordinate values when the frequency of the alternating current output by the first inverter 32 exceeds the threshold frequency.

When the upper nozzle 12a further moves in the direction of arrow Am and the leading portion of the upper nozzle 12a in the moving direction approaches the side wall 17e opposite to the side wall 17d of the recess 17a of the workpiece 17 (position X-3), as shown in FIG. 5, the leading portion of the upper nozzle 12a and the upper surface US of the workpiece 17 come into contact. As a result, the leading portion of the funnel 12b of the upper nozzle 12a is partially obstructed by the upper surface US of the workpiece 17. In FIG. 5, the wire electrode 16 is not in contact with the side wall 17e of the recess 17a.

As described above, since the first supply pump 20 is subjected to constant flow rate control in which the discharge flow rate is constant or constant frequency control in which the frequency of the supplied alternating current is constant while the upper nozzle 12a crosses the recess 17a of the workpiece 17, when the upper nozzle 12a approaches the side wall 17e of the recess 17a and the funnel 12b is partially obstructed, the pressure of the machining fluid in the downstream pipe 23b of the first supply pump 20 increases. Even if the pressure of the machining fluid in the pipe 23b begins to increase, the wire electrode 16 has not yet reached the side wall 17e of the recess 17a, as shown in FIG. 5.

When the wire electrode 16 reaches the side wall 17e of the recess 17a, discharge begins between the workpiece 17 and the portion of the wire electrode 16 exposed in the recess 17a. After the wire electrode 16 comes into contact with the side wall 17e of the recess 17a, when the upper nozzle 12a further moves in the direction of arrow Am relative to the workpiece 17, the side wall 17e is scraped and a gap GPm is formed in the workpiece 17. Specifically, since the portion of the wire electrode 16 exposed in the recess 17a enters the workpiece 17, control of the machining fluid discharged from the upper nozzle 12a must be returned to the previous constant pressure control.

In the present embodiment, when the discharge pressure of the first supply pump 20 exceeds a predetermined value while the first supply pump 20 is under constant flow rate control in which the discharge amount is constant or constant frequency control in which the frequency of the supplied alternating current is constant, the control method of the first supply pump 20 is switched from constant flow rate control or constant frequency control to constant pressure control in which the discharge pressure of the first supply pump 20 is constant. The constant discharge pressure of the first supply pump 20 at this time is the target pressure described above.

The judgment unit 54 monitors the pressure detected by the first pressure sensor 30 in this manner, and when the pressure exceeds the threshold pressure, the control method of the first supply pump 20 is switched from constant flow rate control or constant frequency control to constant pressure control.

The judgment unit 54 commands the power supply 38 to increase the pulsed power applied between the wire electrode 16 and the workpiece 17 to the previous pulsed power when the pressure detected by the first pressure sensor 30 exceeds the threshold pressure. This increase in pulsed power can be implemented by increasing one or both of the pulse width and pulse current.

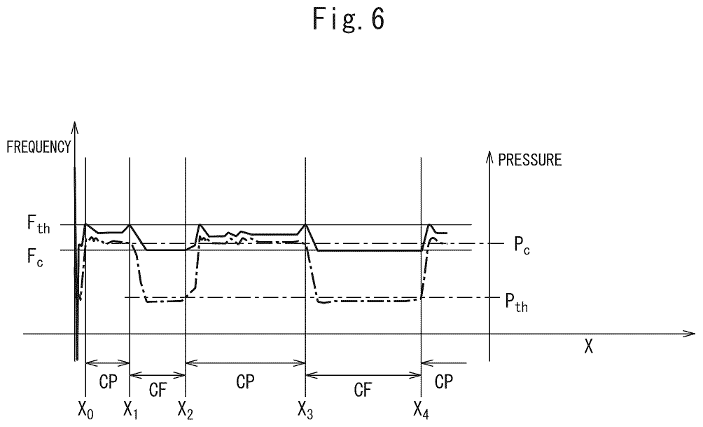

FIG. 6 is a graph showing changes in the frequency of the current output by the first inverter 32 and changes in discharge pressure of the first supply pump 20 (measured pressure of the first pressure sensor 30) when the workpiece shown in FIGS. 2 and 3 is machined by the wire electric-discharge machine according to the present embodiment.

In FIG. 6, the edges of wire electrode 16 and workpiece 17 begin to engage at X=X₀. Thereafter, from X₀ to X₁, machining fluid is supplied to the upper nozzle 12a at a predetermined constant pressure PC under constant pressure control CP. X₀, X₁, X₂, and X₃ represent the positions of the workpiece end edge, side wall 17d, side wall 17e, and side wall 17f, respectively, in the X direction (FIG. 3).

As described above, when the upper nozzle 12a reaches the position X-2 in FIGS. 2 and 3 and approaches the side wall 17d of the recess 17a of the workpiece 17, an opening NO is formed at the leading portion of the upper nozzle 12a, and as a result, the pressure value measured by the pressure sensor 30 tends to be reduced, and the frequency of the current output by the first inverter 32 gradually increases accordingly.

When the wire electrode 16 reaches the vicinity of X=X₁, the frequency F of the current output by the first inverter 32 becomes a predetermined threshold frequency Fₜₕ, and the control method of the first supply pump 20 is switched from constant pressure control CP to constant flow rate control. In the present embodiment, the control method for the first supply pump 20 is switched from feedback control based on the difference between target pressure and discharge pressure to constant frequency control CF based on the frequency command output from the pump control unit 52. In this manner, a current with a constant frequency FC is supplied from the first inverter 32 to the first supply pump 20.

When the upper nozzle 12a moves further and reaches position X-3 in FIGS. 2 and 3, and the leading portion of the upper nozzle 12a in the moving direction approaches the side wall 17e opposite to the side wall 17d of the recess 17a of the workpiece 17, since the leading portion of the funnel 12b of the upper nozzle 12a is partially obstructed by the upper surface US of the workpiece 17, the pressure value measured by the pressure sensor 30 tends to increase.

When the wire electrode 16 reaches the vicinity of X=X₂, the pressure value measured by the pressure sensor 30 becomes a predetermined threshold pressure Pₜₕ, and the control method of the first supply pump 20 is switched from the previous constant flow rate control (or constant frequency control CF) to constant pressure control CP. In the present embodiment, the control method for the first supply pump 20 is switched from constant frequency control based on the frequency command output from the pump control unit 52 to feedback control based on the difference between target pressure and discharge pressure. In this manner, machining fluid of a constant pressure Pc is supplied from the first supply pump 20 to the upper nozzle 12a.

When the wire electrode 16 reaches the vicinity of X=X₃, the control method for the first supply pump 20 is switched from constant pressure control CP to constant flow rate control (constant frequency control CF) in the same manner as X=X₁ described above, and when the wire electrode 16 reaches the vicinity of X=X₄, it is switched from constant flow rate control (constant frequency control CF) to constant pressure control CP in the same manner as X=X₂ described above.

Though a preferred embodiment of the present invention in relation to the first supply pump 20 for supplying machining fluid to the upper nozzle 12a has been described, since the pump control unit 52 controls the second supply pump 21 for supplying machining fluid to the lower nozzle 14a independently of the first supply pump 20, the second supply pump 21 is also controlled in the same manner as the first supply pump 20. Specifically, when the second supply pump 21 is controlled by constant pressure control in which the pressure of machining fluid supplied to the lower nozzle is set at a predetermined constant pressure, and the frequency of the current supplied to the second supply pump 21 exceeds a predetermined threshold frequency while the lower nozzle 14a is in close contact with the bottom surface BS of the workpiece 17, the control method of the second supply pump 21 is switched from constant pressure control to constant flow rate control in which machining fluid is discharged from the second supply pump 21 at a predetermined constant flow rate, and during constant flow rate control, when the measured pressure of the second supply pump 21 exceeds a predetermined threshold pressure, the control method of the second supply pump 21 is switched from constant flow rate control to constant pressure control.

### DESCRIPTION OF REFERENCE SIGNS

10 Wire Electric-Discharge Machine
12 Upper Head
12a Upper Nozzle
14 Lower Head
14a Lower Nozzle
16 Wire Electrode
17 Workpiece
18 Machining Fluid Supply Device
20 First Supply Pump
21 Second Supply Pump
37 Workpiece Mount
38 Power Supply
50 Controller

1. A method for controlling a wire electric-discharge machine for applying a predetermined pulsed power between a traveling wire electrode and a workpiece to machine the workpiece, the method comprising the steps of:
bringing a nozzle for ejecting machining fluid in a travel direction of the wire electrode into close contact with the workpiece,
supplying machining fluid to the nozzle by a supply pump,
controlling the supply pump by constant pressure control to maintain a pressure of the machining fluid supplied to the nozzle at a predetermined constant pressure, moving the workpiece relative to the wire electrode in a direction transverse to the travel direction of the wire electrode,
measuring the frequency of current supplied to the supply pump for supplying the machining fluid to the nozzle, and
switching control of the supply pump from constant pressure control to constant flow rate control for supplying a constant flow rate of machining fluid to the nozzle when the measured frequency exceeds a predetermined threshold frequency.

2. The method for controlling a wire electric-discharge machine according to claim 1, further comprising reducing one or both of a pulse width and a pulse current of the pulsed power applied between the wire electrode and the workpiece when the measured frequency exceeds a predetermined threshold frequency.

3. The method for controlling a wire electric-discharge machine according to claim 1, further comprising:
measuring a pressure of the machining fluid supplied to the nozzle, and
while the supply pump is controlled by constant flow rate control, stopping the constant flow rate control for the supply pump when the measured pressure exceeds a predetermined threshold pressure, and controlling the supply pump by the constant pressure control.

4. The method for controlling a wire electric-discharge machine according to claim 3, further comprising increasing one or both of a pulse width and a pulse current of the pulsed power applied between the wire electrode and the workpiece when the measured pressure exceeds a predetermined threshold pressure.

5. The method for controlling a wire electric-discharge machine according to claim 1, wherein the constant flow rate control comprises setting a frequency of a current supplied to the supply pump to a predetermined constant frequency.

6. A method for controlling a wire electric-discharge machine for applying a pulsed power between a workpiece and a wire electrode traveling between an upper nozzle and a lower nozzle for ejecting a machining fluid, ejecting the machining toward the workpiece from the upper nozzle and the lower nozzle and machining the workpiece, the method comprising the steps of:
arranging the workpiece such that an upper surface and a bottom surface of the workpiece face each other in the travel direction of the wire electrode,
positioning the upper nozzle so that it can come into close contact with a highest upper surface of the workpiece,
positioning the lower nozzle so that it can come into close contact with a lowest bottom surface of the workpiece,
supplying the machining fluid to each of the upper nozzle and lower nozzle at a predetermined constant pressure,
moving the workpiece relative to the wire electrode in a direction transverse to the travel direction of the wire electrode,
measuring a frequency of a current supplied to a first supply pump for supplying machining fluid to the upper nozzle and a pressure of the machining fluid supplied to the upper nozzle,
measuring a frequency of a current supplied to a second supply pump for supplying machining fluid to the lower nozzle and a pressure of the machining fluid supplied to the lower nozzle,
while the upper nozzle is in close contact with the upper surface of the workpiece, controlling the first supply pump by constant pressure control for maintaining the pressure of the machining fluid supplied to the upper nozzle at a predetermined constant pressure,
while the lower nozzle is in close contact with the bottom surface of the workpiece, controlling the second supply pump by constant pressure control for maintaining the pressure of the machining fluid supplied to the lower nozzle at a predetermined constant pressure, and
when the frequency of either or both of the current supplied to the first supply pump and the current supplied to the second supply pump exceeds a predetermined threshold frequency, switching the control of the supply pump that is supplied with a current exceeding the threshold frequency from the constant pressure control to constant flow rate control for discharging the machining fluid at a predetermined constant flow rate.

7. The method for controlling a wire electric-discharge machine according to claim 6, further comprising reducing one or both of a pulse width and a pulse current of the pulsed power applied between the wire electrode and the workpiece when the measured frequency of one or both of the first and second supply pumps exceeds a predetermined threshold frequency.

8. The method for controlling a wire electric-discharge machine according to claim 6, further comprising, while one or both of the first and second supply pumps are controlled by constant flow rate control, when the measured pressure exceeds a predetermined threshold pressure, switching the constant flow rate control to constant pressure control for the supply pump that discharges the machining fluid that exceeds the predetermined threshold pressure.

9. The method for controlling a wire electric-discharge machine according to claim 8, further comprising increasing one or both of a pulse width and a pulse current of the pulsed power applied between the wire electrode and the workpiece when the measured pressure of one or both of the first and second supply pumps exceeds a predetermined threshold pressure.

10. The method for controlling a wire electric-discharge machine according to claim 6, wherein the constant flow rate control comprises setting a frequency of a current supplied to the supply pump to a predetermined constant frequency.

11. A wire electric-discharge machine for applying a pulsed power between a workpiece and a wire electrode traveling between an upper nozzle and a lower nozzle for ejecting a machining fluid, ejecting the machining toward the workpiece form the upper nozzle and the lower nozzle and machining the workpiece, comprising:
a workpiece mount for positioning the workpiece such that an upper surface and a bottom surface of the workpiece face each other in the travel direction of the wire electrode, the upper nozzle which can come into close contact with a highest upper surface of the workpiece,
the lower nozzle which can come into close contact with a lowest bottom surface of the workpiece,
first and second supply pumps for supplying the machining fluid to each of the upper nozzle and lower nozzle,
a feed device for moving the workpiece mount to which the workpiece is affixed relative to the wire electrode in a direction transverse to the travel direction of the wire electrode,
first and second pressure gauges for measuring discharge pressures of the first and second supply pumps, and
a controller for controlling the first and second supply pumps, wherein
the controller, while the upper nozzle is in close contact with the upper surface of the workpiece, controls the first supply pump by constant pressure control for maintaining the pressure of the machining fluid supplied to the upper nozzle at a predetermined constant pressure, while the lower nozzle is in close contact with the bottom surface of the workpiece, controls the second supply pump by constant pressure control for maintaining the pressure of the machining fluid supplied to the lower nozzle at a predetermined constant pressure, and when the frequency of either or both of a current supplied to the first supply pump and a current supplied to the second supply pump exceeds a predetermined threshold frequency, switches the control of the supply pump that is supplied with a current exceeding the threshold frequency from the constant pressure control to constant flow rate control for discharging the machining fluid at a predetermined constant flow rate.
